(19) United States
(12) Patent Application Publication
(10) Pub. No.: US 2018/0297227 A1
(43) Pub. Date: Oct. 18, 2018

(54) CUTTING TOOL

(71) Applicant: TTI (MACAO COMMERCIAL OFFSHORE) LIMITED, Macau (MO)

(72) Inventor: J. Luke Jenkins, Anderson, SC (US)

(21) Appl. No.: 15/952,676

(22) Filed: Apr. 13, 2018

Related U.S. Application Data
(60) Provisional application No. 62/485,437, filed on Apr. 14, 2017.

(51) Int. Cl. B26D 3/16; B26B 25/00

(52) U.S. Cl. CPC B26D 3/169; B26B 25/005

(57) ABSTRACT

A cutting tool is configured to cut a tube. The cutting tool comprises a tube cutter. The tube cutter includes a housing having a blade opening and a profile defining a tube opening configured to receive the tube. The tube cutter also includes a blade arranged in the blade opening and extending into the tube opening. The cutting tool further comprises a handle having a grip portion and a mounting portion, the mounting portion configured to removably attach the tube cutter to the handle. The cutting tool also comprises a ratcheting mechanism configured to alternatively lock and unlock the tube cutter for rotation with the handle. When the tube cutter is attached to the mounting portion, the tube is arranged in the tube opening, and the handle is rotated in a first direction about the pipe, the ratcheting mechanism locks the tube cutter for rotation with the handle, such that the tube cutter rotates with the handle and the blade cuts the tube. When the tube cutter is attached to the mounting portion, the tube is arranged in the tube opening, and the handle is rotated in a second direction that is opposite the first direction about the pipe, the ratcheting mechanism allows the handle to rotate relative to the tube cutter.

### CROSS-REFERENCE TO RELATED APPLICATIONS

This application claims priority to co-pending U.S. Provisional Patent Application No. 62/485,437 filed on Apr. 14, 2017, the entire content of which is incorporated herein by reference.

### FIELD OF THE INVENTION

The present invention relates to cutting tools, and more particularly to tube cutting tools.

### BACKGROUND OF THE INVENTION

Some tube cutters use a blade with a cutting portion to perform a circumferential cut around an area of tube.

### SUMMARY OF THE INVENTION

The invention provides, in one aspect, a cutting tool configured to cut a tube. The cutting tool comprises a tube cutter. The tube cutter includes a housing having a blade opening and a profile defining a tube opening configured to receive the tube. The tube cutter also includes a blade arranged in the blade opening and extending into the tube opening. The cutting tool further comprises a handle having a grip portion and a mounting portion, the mounting portion configured to removably attach the tube cutter to the handle. The cutting tool also comprises a ratcheting mechanism configured to alternatively lock and unlock the tube cutter for rotation with the handle. When the tube cutter is attached to the mounting portion, the tube is arranged in the tube opening, and the handle is rotated in a first direction about the pipe, the ratcheting mechanism locks the tube cutter for rotation with the handle, such that the tube cutter rotates with the handle and the blade cuts the tube. When the tube cutter is attached to the mounting portion, the tube is arranged in the tube opening, and the handle is rotated in a second direction that is opposite the first direction about the pipe, the ratcheting mechanism allows the handle to rotate relative to the tube cutter.

The invention provides, in another aspect, a cutting tool assembly configured to cut a plurality of tubes having different diameters. The cutting tool assembly comprises a handle having a grip portion and a mounting portion, the mounting portion forming one part of a ratcheting mechanism. The cutting tool assembly further comprises a plurality of tube cutters configured to be selectively attached to the mounting portion. Each of the plurality of tube cutters includes a housing having a blade opening and a profile defining a tube opening that defines a longitudinal axis and is configured to receive one of the plurality of tubes. Each of the plurality of tube cutters also includes a blade arranged in the blade opening and extending into the tube opening. Each of the plurality of tube cutters also includes a second part of the ratcheting mechanism. Each of the tube openings has a different size, each different size corresponding to one of the different diameters of the tubes. When one of the plurality of tube cutters is attached to the mounting portion, one of plurality of tubes is arranged in the tube opening, and the handle is rotated in a first direction about the longitudinal axis, the ratcheting mechanism locks the attached tube cutter for rotation with the handle, such that the attached tube cutter rotates with the handle and the blade cuts the tube. When one of the plurality of tube cutters is attached to the mounting portion, one of the plurality of tubes is arranged in the tube opening, and the handle is rotated in a second direction that is opposite the first direction about the longitudinal axis, the ratcheting mechanism allows the handle to rotate relative to the attached tube cutter.

The invention provides, in yet another aspect, a cutting tool configured to cut a tube. The cutting tool comprises a tube cutter including a housing having a blade opening, a roller opening, and a profile defining a tube opening that is configured to receive the tube, the tube opening defining a longitudinal axis. The tube cutter also includes a blade arranged in the blade opening and extending into the tube opening. The tube cutter also includes a roller rotatably mounted to the housing, arranged in the roller opening, and extending into the tube opening. The cutting tool also comprises a handle having a grip portion and a mounting portion, the mounting portion configured to removably attach the tube cutter to the handle. The cutting tool also comprises a ratcheting mechanism including a pawl on one of the tube cutter and mounting portion and a toothed portion on the other of the tube cutter and mounting portion. When the tube cutter is attached to the mounting portion, the tube is arranged in the tube opening, and the grip portion is rotated in a first direction about the tube, the pawl is locked against the toothed portion, such that the tube cutter rotates with the handle and the blade cuts the tube. When the tube cutter is attached to the mounting portion, the tube is arranged in the tube opening, and the grip portion is rotated in a second direction that is opposite the first direction about the longitudinal axis, the pawl moves unrestricted over the toothed portion, such that the handle to rotate relative to the tube cutter.

Other features and aspects of the invention will become apparent by consideration of the following detailed description and accompanying drawings.

### BRIEF DESCRIPTION OF THE DRAWINGS

FIG. 1 is a perspective view of a cutting tool.

FIG. 2 is a perspective view of a tube cutter of the cutting tool of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

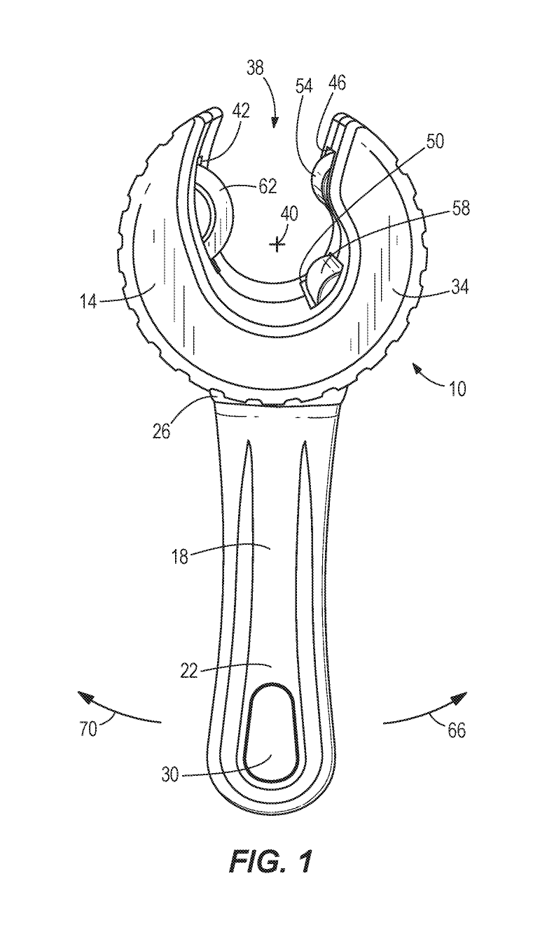

As shown in FIG. 1, a cutting tool 10 for cutting a tube is provided. A tube may include any tube, pipe, or other cylindrical structure capable of being cut. The tool 10 includes a tube cutter 14 and a handle 18. The handle 18 has a grip portion 22 and a mounting portion 26, to which the tube cutter 14 is removably mounted. The cutting tool 10 also includes a ratcheting mechanism (not shown) with a first part on the mounting portion 26 and the second part on the tube cutter 14. In some embodiments, the ratcheting mechanism includes a pawl that interfaces with a gear or toothed portion. In some embodiments, the pawl is on the mounting portion 26 and the toothed portion is on tube cutter 14. In other embodiments, the pawl is on the tube cutter 14 and the toothed portion is on the mounting portion 26. The grip portion 22 of the handle 18 includes a handle opening 30, which a clip or lanyard (not shown) may be set through, in order to secure the handle 18 to an operator's tool belt or clothing.

The tube cutter 14 includes a housing 34 with a generally “C-shaped” profile and a tube opening 38 that allows the tube to be cut to be arranged within the tube cutter 14. The tube opening 38 defines a longitudinal axis 40 along which the tube can be arranged. The housing 34 also includes a blade opening 42 and first and second roller openings 46, 50. A first roller 54 is arranged in the first roller opening 46 and extends into the tube opening 38. A second roller 58 is arranged in the second roller opening 50 and extends into the tube opening 38. The first roller 54 and the second roller 58 are rotatably mounted to the housing 34, such that the rollers 54, 58 can freely rotate against a surface of the tube to be cut. A blade 62 is also mounted to the housing 34, is arranged in the blade opening 42, and extends into the tube opening 38.

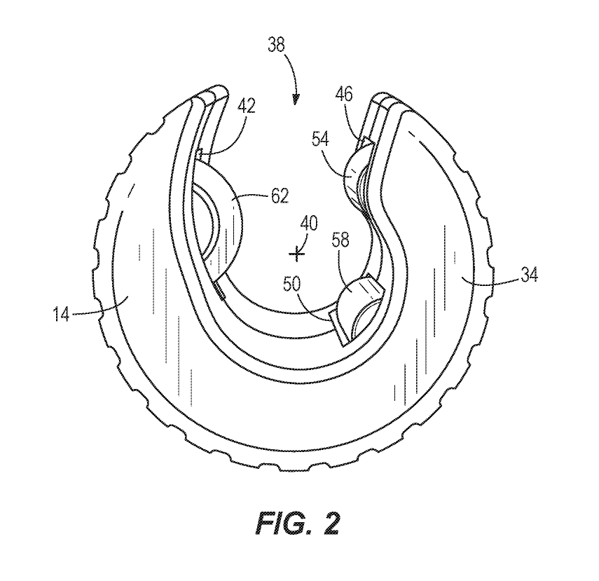

The tube cutter 14 is removably attached to the mounting portion 26 of the handle 18. When the tube cutter 14 is attached to the mounting portion 26 and a tube is arranged in the tube opening 38, the ratcheting mechanism selectively locks the tube cutter 14 for rotation with the handle 18, as described in further detail below. In some embodiment, there are a plurality of tube cutters 14 that may be interchangeably mounted to the handle 18, with each tube cutter 14 corresponding to a different diameter of tube to be cut. Specifically, the different tube cutters 14 may have different size tube openings 38, which correspond to, for example, 0.5″, 1″, and 1.25″ diameter tubes. For example, the tube cutter 14 mounted on the mounting portion 26 in FIG. 1 has a tube opening 38 to receive a 0.5″ diameter area of tube and the tube cutter 14 shown in FIG. 2 has a tube opening 38 to receive a 1.25″ diameter area of tube.

In operation, an operator identifies an area of tube to be cut, such as a 0.5″ diameter section of copper piping. The operator then selects the appropriate tube cutter 14 with the correct sized tube opening 38, in this instance, a tube opening 38 configured to receive a section of tube with 0.5″ diameter. The operator attaches the 0.5″ tube cutter 14 to the mounting portion 26 of the handle 18. The operator places the cutting tool 10 onto the area of tube by fitting the tube within the tube opening 38 in the C-shaped profile. The operator ensures that the blade 62 is perpendicular to and contacting an external surface of the tube.

The operator then grasps the grip portion 22 and rotates the handle 18 about the longitudinal axis 40 in a first direction 66, which causes the tube cutter 14 to rotate with the handle 18 about the tube. In other words, the first direction 66 is the direction whereby the ratchet is locked (i.e., the pawl is locked against the tooth portion). As the operator rotates the handle 18 in the first direction 66, the blade 62 makes a circumferential cut around the external surface of the tube and the first and second rollers 54, 58 roll along the tube. The blade 62 is biased inwards by a biasing member (not shown), towards the longitudinal axis 40. When the tube is received in the tube opening 38, the blade 62 is biased against the tube.

Once the operator has rotated the handle 18 about the longitudinal axis 40 a certain amount, the operator then rotates the handle 18 about the longitudinal axis 40 in a second direction 70, which is opposite the first direction 66. When the tube is received in the tube opening 38 and the handle is rotated in the second direction 70, the tube cutter 14 self-tightens around the tube. As the handle 18 rotates in the second direction 70, the ratchet is no longer locked (i.e., the pawl is not locked against the toothed portion and instead moves unrestricted over the toothed portion). Thus, the tube cutter 14 does not rotate with the handle 18 in the second direction 70, and instead remains fixed with respect to the tube. The tube cutter 14 therefore does not perform any cutting action while the handle is rotated in the second direction 70.

Once the operator has finished rotating the handle 18 in the second direction 70, the operator again rotates the handle 18 in the first direction 66. The pawl is again locked with the toothed portion, thereby locking the tube cutter 14 for rotation with the handle 18, so the tube cutter 14 may continue its circumferential cut about the tube. The operator repeats this procedure of alternately rotating the handle in first and second directions 66, 70 until the tube cutter 14 has performed a 360 degree cut about the tube. Once the cut is complete, the operator may remove the tool 10 from the tube and separate the tube into two sections, which have now been separated by the cut.

Next the operator identifies a new area of tube to be cut, such as a 1.25″ diameter section of PVC tubing. The operator then removes the 0.5″ tube cutter 14 from the mounting portion 26 and attaches the 1.25″ tube cutter 14 on the mounting portion. The operator then places the cutting tool 10 onto the area of 1.25″ diameter tubing by fitting the tube within the opening 38 in the C-shaped profile. The operator then performs the ratcheting cutting procedure as described above.

The ratcheting mechanism of the cutting tool 10 permits an operator to use the cutting tool 10 in small, cramped spaces where tube needs to be cut. Instead of having to rotate a handle or cutting tool a full 360 degrees around the section of tube, an operator only needs to rotate the handle 18 back and forth in a very small range in order to actuate the ratcheting mechanism, readjust the handle 18 relative to the tube cutter 14, and continue performing the cut.

Various features of the invention are set forth in the following claims.

What is claimed is:

1. A cutting tool configured to cut a tube, the cutting tool comprising:
a tube cutter, the tube cutter including
a housing having a blade opening and a profile defining a tube opening configured to receive the tube, and
a blade arranged in the blade opening and extending into the tube opening;
a handle having a grip portion and a mounting portion, the mounting portion configured to removably attach the tube cutter to the handle; and
a ratcheting mechanism configured to alternatively lock and unlock the tube cutter for rotation with the handle,
wherein when the tube cutter is attached to the mounting portion, the tube is arranged in the tube opening, and the handle is rotated in a first direction about the pipe, the ratcheting mechanism locks the tube cutter for rotation with the handle, such that the tube cutter rotates with the handle and the blade cuts the tube, and
wherein when the tube cutter is attached to the mounting portion, the tube is arranged in the tube opening, and the handle is rotated in a second direction that is opposite the first direction about the pipe, the ratcheting mechanism allows the handle to rotate relative to the tube cutter.

2. The cutting tool of claim 1, wherein the ratcheting mechanism includes a pawl and a toothed portion, and
wherein when the tube cutter is attached to the mounting portion, the tube is arranged in the tube opening, and the handle is rotated in a first direction about the pipe, the pawl is locked against the tooth portion,
wherein when the tube cutter is attached to the mounting portion, the tube is arranged in the tube opening, and the handle is rotated in the second direction about the pipe, the pawl moves unrestricted over the toothed portion.

3. The cutting tool of claim 2, wherein the pawl is on the mounting portion and the toothed portion is on the tube cutter.

4. The cutting tool of claim 2, wherein the pawl is on the tube cutter and the toothed portion is on the mounting portion.

5. The cutting tool of claim 1, wherein the grip portion of the handle includes an opening.

6. The cutting tool of claim 1, wherein the profile is a C-shaped profile.

7. The cutting tool of claim 1, wherein tube opening defines a longitudinal axis, and wherein the blade is biased towards the longitudinal axis.

8. The cutting tool of claim 7, wherein when the tube is received in the tube opening, the blade is biased against the tube.

9. The cutting tool of claim 1, wherein when the tube cutter is attached to the mounting portion, the tube is arranged in the tube opening, and the handle is rotated in the second direction about the pipe, the tube cutter self-tightens onto the tube.

10. The cutting tool of claim 1, wherein the housing includes a first roller opening and the tube cutter includes a first roller arranged in the first roller opening and rotatably coupled to the housing, the first roller extending into the tube opening, the first roller configured to roll along the tube when the tube is arranged in the tube opening and the handle is rotated in the first direction about the pipe.

11. The cutting tool of claim 10, wherein when the tube is received in the opening, the tube cutter is secured on the tube between the blade and the first roller.

12. The cutting tool of claim 10, wherein the housing includes a second roller opening and the tube cutter includes a second roller arranged in the second roller opening and rotatably coupled to the housing, the second roller extending into the tube opening, the second roller configured to roll along the tube when the tube is arranged in the tube opening and the handle is rotated in the first direction about the pipe.

13. The cutting tool of claim 1, wherein the tube cutter is one of a plurality of tube cutters, and wherein each of the plurality of tube cutters is configured to be removably attached to the mounting portion of the handle.

14. The cutting tool of claim 13, wherein the openings of the plurality of tube cutters are each a different size corresponding to a plurality of diameters of different tubes.

15. A cutting tool assembly configured to cut a plurality of tubes having different diameters, the cutting tool assembly comprising:
a handle having a grip portion and a mounting portion, the mounting portion forming one part of a ratcheting mechanism; and
a plurality of tube cutters configured to be selectively attached to the mounting portion, each of the plurality of tube cutters including
a housing having a blade opening and a profile defining a tube opening that defines a longitudinal axis and is configured to receive one of the plurality of tubes,
a blade arranged in the blade opening and extending into the tube opening, and
a second part of the ratcheting mechanism,
wherein each tube opening has a different size, each different size corresponding to one of the different diameters of the tubes,
wherein when one of the plurality of tube cutters is attached to the mounting portion, one of plurality of tubes is arranged in the tube opening, and the handle is rotated in a first direction about the longitudinal axis, the ratcheting mechanism locks the attached tube cutter for rotation with the handle, such that the attached tube cutter rotates with the handle and the blade cuts the tube, and
wherein when one of the plurality of tube cutters is attached to the mounting portion, one of the plurality of tubes is arranged in the tube opening, and the handle is rotated in a second direction that is opposite the first direction about the longitudinal axis, the ratcheting mechanism allows the handle to rotate relative to the attached tube cutter.

16. The cutting tool assembly of claim 15, wherein the different sizes correspond to different diameters including diameters of 0.5 inches, 1.0 inches, and 1.25 inches.

17. A cutting tool configured to cut a tube, the cutting tool comprising:
a tube cutter, the tube cutter including a housing having a blade opening, a roller opening, and a profile defining a tube opening that is configured to receive the tube, the tube opening defining a longitudinal axis, a blade arranged in the blade opening and extending into the tube opening, and a roller rotatably mounted to the housing, arranged in the roller opening, and extending into the tube opening;
a handle having a grip portion and a mounting portion, the mounting portion configured to removably attach the tube cutter to the handle; and
a ratcheting mechanism including a pawl on one of the tube cutter and mounting portion and a toothed portion on the other of the tube cutter and mounting portion, wherein when the tube cutter is attached to the mounting portion, the tube is arranged in the tube opening, and the grip portion is rotated in a first direction about the tube, the pawl is locked against the toothed portion, such that the tube cutter rotates with the handle and the blade cuts the tube, and wherein when the tube cutter is attached to the mounting portion, the tube is arranged in the tube opening, and the grip portion is rotated in a second direction that is opposite the first direction about the longitudinal axis, the pawl moves unrestricted over the toothed portion, such that the handle to rotate relative to the tube cutter.

18. The cutting tool of claim 17, when the tube cutter is attached to the mounting portion, the tube is arranged in the tube opening, and the grip portion is rotated in the second direction about the longitudinal axis, the tube cutter self-tightens onto the tube.

19. The cutting tool of claim 18, wherein the grip portion of the handle includes an opening.

20. The cutting tool of claim 19, wherein the blade is biased towards the longitudinal axis.
